(19) United States
(12) Patent Application Publication
(10) Pub. No.: US 2022/0273973 A1
(43) Pub. Date: Sep. 1, 2022

(54) MULTI-DUMP VALVE FOR RELEASING LIQUID FROM A CONTAINER

(71) Applicant: DONMARK HOLDINGS INC., Delta (CA)

(72) Inventor: Donald Brian ARNEY, Delta (CA)

(21) Appl. No.: 17/671,318

(22) Filed: Feb. 14, 2022

Related U.S. Application Data
(60) Provisional application No. 63/149,188, filed on Feb. 12, 2021.

(51) Int. Cl. A62C 3/02

(52) U.S. Cl. CPC A62C 3/0235

(57) ABSTRACT

A valve mountable to a bottom of a container around an opening, such as an aerial firefighting bucket, and has a hub and telescoping arms extending radially from the hub. The telescoping arms are connected to the hub and to the bottom of the container. Hence, they radiate from the hub to a periphery around the opening. The hub may be raised and lowered with respect to the opening. When raised the telescoping arms extend and when lowered the telescoping arms contract. A valve flap is connected to the telescoping arms and covers the opening when the hub is lowered to inhibit liquid flow out of the opening and exposes part of the opening as the hub is raised to allow liquid to flow past the valve flap.

### FIELD OF THE INVENTION

The invention pertains to a collapsible multi dump valve for releasing volumes of liquid from a container, such as an aerial firefighting bucket and in particular a collapsible aerial firefighting bucket, which collapsible valve may be used to regulate liquid flow out of the container.

### BACKGROUND OF THE INVENTION

Helicopter carried firefighting buckets are well known for use in fighting forest fires. These buckets, at their simplest, may comprise a rigid or flexible reservoir or body for holding a volume of water, a sling to suspend the reservoir from a helicopter, a valve, and an actuator that is controlled from inside the helicopter to operate the valve to release the water from the reservoir over the fire.

Firefighting buckets for carrying by helicopter are well known, and typical buckets are disclosed in U.S. Pat. Nos. 4,474,245 and 4,576,237. Improvements to the bucket shown in these patents have been devised over the years, and some of these improvements are shown in U.S. Pat. No. 5,560,429. These patents disclose firefighting buckets made of pliable fabric material having an open upper end with a rim to facilitate filling from an open body of water, a side wall extending downwardly from the rim, and a bottom cooperating with the side wall and having an opening. A tubular extension made of pliable material extends from an opening in the bottom to a free end formed with a discharge port to serve as a dump valve. The discharge port has an array of grommeted openings extending there-around to receive a plurality of cords so that the tubular extension can be drawn upwardly into the bucket by the cords before the bucket is filled with water. The discharge port has a circumferential sealing lip made of soft and resilient material, which forms two opposite lip portions that are brought into sealing engagement with each other to minimize water leakage from the tubular extension when the dump valve is positioned below the water surface in the bucket. The plurality of cords function as valve control lines, also known as purse lines, and pass through the aligned openings to draw the sealing lips into engagement with each other when the cords are tightened. Tension in the cords supports the tubular extension, and the extension is drawn upwardly through the bucket to be supported in a position which can be below an upper level of water within the bucket. Weight of water acting on the tubular extension tensions the cords and ambient pressure of water acting on the sealing lips augments initial sealing generated by tension in the cords. To dump the water from the bucket, the sleeve is released by rapidly loosening the valve control lines, or purse lines, by a control or trip mechanism, which permits the tubular extension to evert quickly through the opening in the bottom of the bucket. The lip portions are opened under the weight of water, permitting rapid discharge of water with negligible obstruction.

While these types of collapsible firefighting buckets have been widely successful, they share a disadvantage that the valve mechanism does not permit multiple water dumps as it cannot be retracted easily against the head pressure produced when a significant volume of water remains in the bucket. To address the above disadvantage in these kinds of collapsible firefighting buckets, the tubular extension dump valve may be replaced by mechanical valves such as disclosed in U.S. Pat. Nos. 6,182,990 and 9,265,977. These mechanical valves permit fine control of release of water from the bucket, but their mechanical complexity adds to the weight and cost of the firefighting buckets, and their bulk interferes with the collapsing of collapsible firefighting buckets.

In other existing firefighting buckets, the valve may consist of a simple flapper valve located on a bottom interior surface of the reservoir and operated by a remotely controlled actuator. A flapper valve typically includes a base plate having an outlet therein, a flat flapper member disposed over-top of the base plate to block the outlet, and a hinge connected between an edge of the flapper member and the base plate to hingedly connect the flapper member to the base plate permitting the flapper member to alternately block and expose the outlet. While such a valve is mechanically simple and robust, it may have significant shortcomings.

In fire-fighting buckets, it may be desirable to place the valve at the bottom of the reservoir so as to permit the reservoir to be completely drained therethrough. In this location, the force of the full head of water in the reservoir resists the hinging of the flapper member and thereby resists the opening of the flapper valve. The resistive force increases directly as the area of the flapper member. Therefore, if a flapper valve having a reasonably large flapper member is provided, such that the reservoir may be dumped reasonably quickly, a fairly powerful motor may be required to actuate the flapper, resulting in increased weight and power consumption. Furthermore, the operation of the valve may create turbulent flow, causing the water to disperse laterally as it is dumped. As previously stated, one edge of the flapper member may be hingedly connected to the base portion. Therefore, when the flapper valve is opened, water may be blocked by the hinged edge while being permitted to flow to the outlet past the remaining edges. This may create unbalanced flows and turbulence. This effect may be exacerbated if the valve is opened only part way so as to operate as a metering valve. In firefighting, lateral dispersal may be undesirable as the water may be more susceptible to evaporation before reaching the ground and also because some of the water may overshoot the desired target.

Lastly, a flapper valve may not be adequately controllable to rapidly shut off the flow of water to permit multiple dumps, for example. When the valve is open, hydrostatic forces acting on the flapper member may tend to keep the valve open, canceling some of the hydrodynamic forces caused by the outflow of water which may tend to close the valve. Furthermore, the turbulence caused by the valve, as previously described, may further cancel the hydrodynamic forces. Such cancellations may slow the closure of the valve, causing the operator to dump a larger volume water than necessary, possibly the entire bucket load, in a location regardless of whether or not the full volume of water is required at that location.

Some existing buckets may use a butterfly valve in place of the flapper valve. A butterfly valve typically includes a longitudinally extending axle having first and second coplanar plates extending laterally therefrom. The butterfly valve may be connected to a bottom portion of the bucket and located in an opening therein. When closed, the first plate may seal against an interior surface of the bucket while the second plate may seal against an exterior surface of the bucket. The valve may be opened by rotating the first and second plates about the axle and may be fully opened by rotating the plates to a position perpendicular to their closed position. While the butterfly valve is hydrodynamically balanced, it may tend to cause lateral dispersal when operated as a metering valve and may be difficult to seal as one plate may be located inside the bucket and the other plate may be located outside the bucket.

Furthermore, both butterfly valves and flapper valves may tend to provide relatively poor seals as they may use flat gaskets which may only resist liquid flow directed normally to a plane of the gasket and which may permit liquid leakage directed parallel the plane of the gasket.

Accordingly, it would be desirable to provide a mechanically simple multi-dump valve in a firefighting bucket, and one that preferably collapses such that when used in a collapsible firefighting bucket it does not impede the collapse of the bucket. It would also be desirable that the multi-dump valve be less affected by hydrostatic and hydrodynamic forces directed so as to oppose its movement such that the force required to actuate the valve would be considerably less with the advantage that the actuating hardware may be reduced to achieve considerable weight reduction and that motors with a reduced power demand may be used with the advantage of a reduced electric power demand. In addition, it would be desirable for the valve apparatus to be more easily serviceable so that the seals in the apparatus are more easily replaced when worn or damaged.

### SUMMARY OF THE INVENTION

In one aspect, the present invention provides a mechanically simple multi-dump valve for releasing volumes of liquid from a container, such as an aerial firefighting bucket and in particular a collapsible aerial firefighting bucket. In another aspect, the present invention provides an aerial firefighting bucket having such valve. The multi-dump valve comprises a valve assembly having a hub that is positioned centrally with respect to an opening in the bottom of the reservoir or bucket and from which radially extend a plurality of telescoping arms, each of which includes a hub end that is hingedly connected to the hub and a remote end that is hingedly connected to a portion of a bottom interior surface of the reservoir or bucket. The plurality of telescoping arms radiates from the hub to the circumference of the opening and hingedly connect the hub to the bottom interior surface adjacent the opening in a manner that the hub may be raised and lowered with respect to the opening. As the hub is raised, the telescoping arms extend, and as the hub is lowered, the telescoping arms contract.

A valve flap of a flexible liquid impervious material and being of sufficient dimensions to cover the opening is positioned underneath the valve assembly and is connected to each telescoping arm by a connection at an adjacent location about the peripheral edge of the valve flap. The connections are positioned along the lengths of the telescoping arms so that the peripheral edge of the valve flap covers the opening when the valve assembly is in a lowered position relative to the opening, and the peripheral edge provides a gap to the opening when the valve assembly is in a raised position relative to the opening to allow liquid to flow out of the bucket. In the raised or open position, the lateral surface area of the valve, upon which the liquid head pressure in the reservoir or bucket acts tending to urge the valve downward, is reduced as the valve flap folds inward with the extension of the telescoping arms.

In some aspects, the present invention provides, a valve mountable to a bottom of a container around an opening, such as an aerial firefighting bucket, to enable liquid to be released from the bottom of the container, the valve comprising: a hub and a plurality of spaced telescoping arms extending radially from the hub, each telescoping arm defines a hub end that is hingedly connected to the hub and a remote end that may be connected to the bottom of the container such that the telescoping arms radiate from the hub to a periphery around the opening; the hub being operable to be raised and lowered with respect to the opening such that as the hub is raised the telescoping arms extend and as the hub is lowered the telescoping arms contract; a flexible liquid impervious valve flap of sufficient dimension to cover the opening and connected to the telescoping arms such that the valve flap is positioned to cover the opening as the hub is lowered toward the opening to inhibit liquid flow out of the opening, and to expose part of the opening as the hub is raised away from the opening to allow liquid to flow past the valve flap; and a centrally located connector on the hub that may be coupled to an actuator mechanism for raising and lowering the hub relative to the bottom.

In some embodiments, the valve may comprise a stop member on at least one of the hub ends that engages the hub to interfere with lowering of the hub beyond a closed position of the valve in which the valve flap covers the opening.

In some embodiments, the remote ends may be removably connected to the bottom.

In some embodiments, the valve may comprise a hinged mount on the remote ends by which the remote ends may be connected for hinged movement to the bottom.

In some embodiments, the valve may comprise a removable hinged mount on the remote ends by which the remote ends may be removably connected for hinged movement to the bottom.

In some embodiments, the valve may comprise a ring seal around the periphery of the valve flap for engaging the bottom around the opening.

In some embodiments, each telescoping arm may comprise a fixed segment that is hingedly connected to the hub and a rod segment slidably mounted to the fixed segment for telescoping longitudinal movement relative thereto and defining the remote end of the telescoping arm.

In some embodiments, the valve may further comprise a stop member on at least one of the hub ends of the fixed segments to engage the hub to interfere with lowering of the hub beyond a closed position of the valve in which the valve flap covers the opening.

In some embodiments, when the valve is in the closed position, the fixed segments may span the opening and the valve flap may be connected to the fixed segments such that the valve flap covers the opening, and in an open position, the fixed segments and the valve flap define a gap to the opening. In some embodiments, the valve may further comprise a ring seal around the periphery of the valve flap for engaging the bottom around the opening.

In some embodiments, the fixed segment may comprise parallel plates hingedly connected to the hub and a low friction guide mounted between the plates to slidably support the rod segment.

In some embodiments, the rod segment may further include a slide stop cooperating with the guide to prevent detachment of the rod segment from the guide.

In some aspects, the present invention provides a firefighting bucket comprising: an open bucket body having an open upper rim to facilitate filling from an open body of water, a side wall extending downwardly from the rim and a bottom cooperating with the side wall and having an opening; and a valve in accordance with an embodiment of the present invention mounted on the bottom and cooperating with the opening to control liquid flow out of the bucket body.

### BRIEF DESCRIPTION OF THE DRAWINGS

Further features and advantages will be apparent from the following detailed description, given by way of example, of preferred embodiments taken in conjunction with the accompanying drawings, wherein:

FIG. 1 is a side view of an embodiment of a firefighting bucket of the present invention shown suspended from a helicopter;

FIG. 2 is a perspective view of the inside bottom of the firefighting bucket of FIG. 1 showing an embodiment of a valve of the present invention in a closed position;

FIG. 3 is a perspective view of the inside bottom of the firefighting bucket of FIG. 1 showing the valve of FIG. 2 in an open position;

FIG. 4 is a plan view from the top of the inside bottom of the firefighting bucket of FIG. 1 showing the valve of FIG. 2 in a closed position;

FIG. 5 is a plan view from the top of the inside bottom of the firefighting bucket of FIG. 1 showing the valve of FIG. 2 in an open position;

FIG. 6 is a simplified schematic cross section view showing the linkage attached to the valve flap and a portion of the bucket shell;

FIG. 7 is a perspective view of the hub and a telescoping arm of the valve of FIG. 2 in isolation; and

FIG. 8 is a close-up view of a portion of the hub and a portion of a telescoping arm of FIG. 7

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention as defined by the claims.

The invention provides a mechanically simple multi-dump valve for releasing volumes of liquid from a container, such as an aerial firefighting bucket and in particular a collapsible aerial firefighting bucket. In another aspect, the present invention provides an aerial firefighting bucket having such valve.

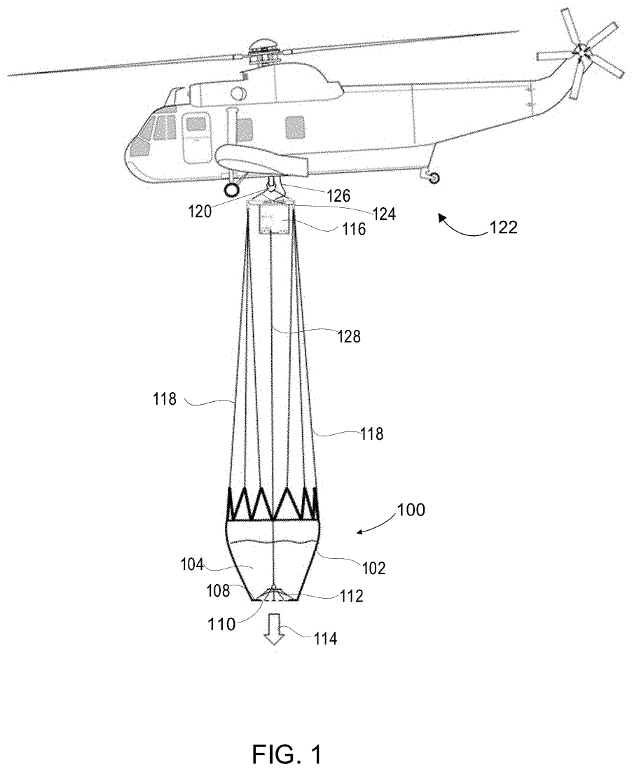

Referring to FIG. 1, a firefighting bucket according to one aspect of the invention is shown generally as firefighting bucket 100. The firefighting bucket 100 comprises a reservoir or shell 102 for containing a volume of water or liquid 104. In a collapsible firefighting bucket 100 the shell 102 comprises a water impermeable flexible material. The shell 102 may include a bottom interior surface 108 having a valve 112 thereon for controllably releasing a stream 114 of liquid through an opening 110 in the bottom interior surface 108 of the firefighting bucket 100. The shell 102 may be suspended from a control head 116 by support cables 118 and the control head 116 may be suspended from cargo hook 120 of helicopter 122 by support cables 124. A control cable 126 may be connected between the helicopter 122 and the control head 116 to transmit instructions from an operator to the control head 116. The control cable 126 may be an electrical cable, a hydraulic hose, or a pneumatic hose, for example. An actuator cable 128 may be connected between the control head 116 and the valve 112 to enable the control head 116 to open and close the valve 112 in response to operator commands.

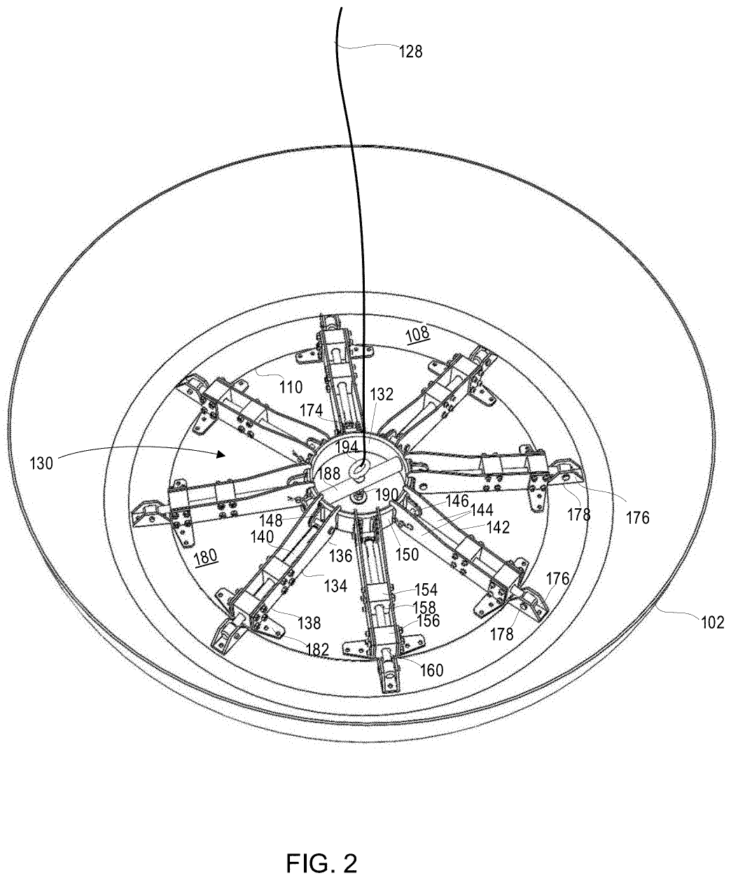

Referring to FIGS. 2-6, valve 112 comprises a valve assembly 130 comprising a hub 132 that is positioned centrally with respect to the opening 110 and from which radially extend a plurality of telescoping arms 134, each of which includes a hub end 136 that is hingedly connected to the hub 132, and a remote end 138 that is hingedly connected to a portion of the bottom interior surface 108 of the bucket 100. Accordingly, the plurality of telescoping arms 134 radiate from the hub 132 to the circumference of the opening 110 and hingedly connect the hub 132 to the bottom interior surface 108 adjacent the opening 110 in a manner that the hub 132 may be raised and lowered with respect to the opening 110. As the hub 132 is raised, the telescoping arms 134 extend, and as the hub 132 is lowered, the telescoping arms 134 contract.

Each telescoping arm 134 comprises a telescoping rod 140 that is received and telescopes within arm portion 142. In the illustrated embodiment, the arm portion 142 comprises a pair of parallel elongate plates 144 hinged at the hub end 136 by a pin 146 passing through the plates 144 and parallel lugs 148 extending from the outer surface 150 of the hub 132. The plates 144 are held in alignment by spacer guides such as intermediate guide 154 and remote guide 156, each of which is provided with longitudinally aligned bores 158 and 160 that slidably receive the telescoping rod 140 to allow extension and retraction of the telescoping arm 134. Preferably, the intermediate guide 154 and remote guide 156 comprise a low friction material surrounding the bores 158 and 160 to facilitate smoother telescoping of the telescoping rod 140 therewithin, such as for example a plastic comprising Polytetrafluoroethylene (PTFE) or the like. Alternatively, the intermediate guide 154 and remote guide 156 may include ball or roller bearings surrounding the bores 158 and 160 to facilitate telescoping of the telescoping rod 140 therewithin.

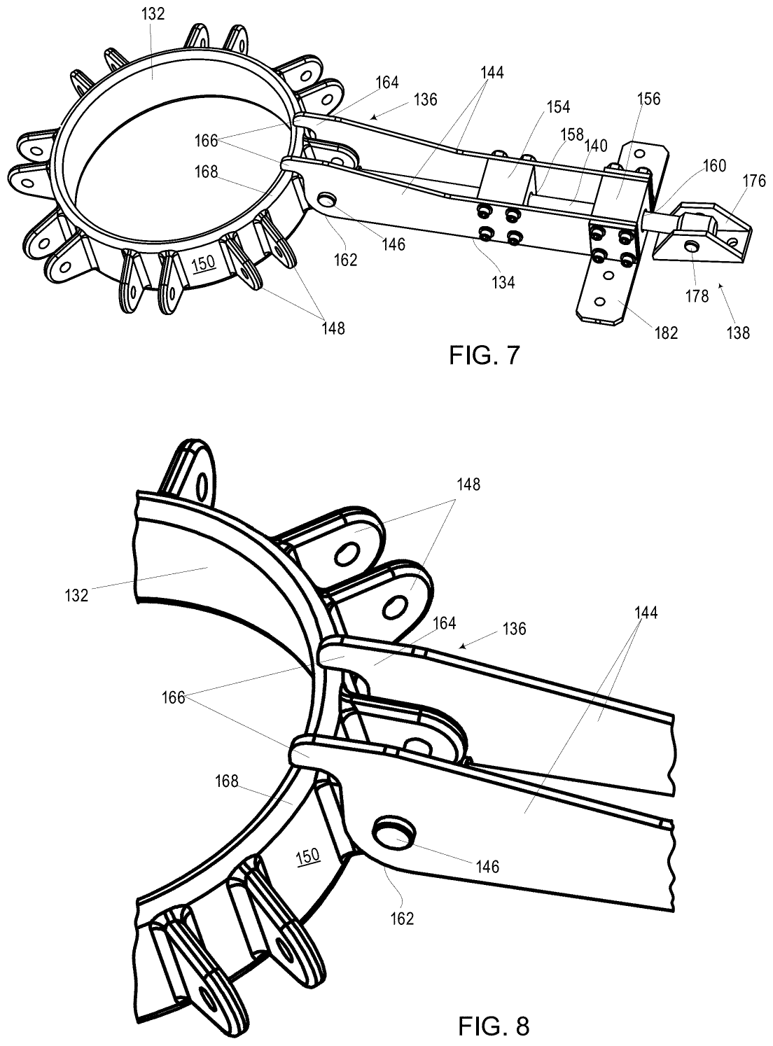

Referring to FIGS. 7 and 8, which show the hub 132 and a telescoping arm 134 in isolation and in close-up, the plates 144 at the hub end 136 each include a radiused lower corner 162 that provides clearance for the plates 144 of the telescoping arm 134 to pivot relative to the hub 132. The upper corner portion 164 of the plates 144 include a protrusion or tab 166 that extends over the upper edge 168 of the hub 132. The tabs 166 function as a stop member as they bear against the upper edge 168 when the hub 132 (and hence the valve assembly 130) reaches a lower limit. These tabs are important to the proper sealing of the valve 112 as they keep the hub 132 level, for example, in the same plane in as the opening 110 of the bucket 100. If the hub 132 is not in the same plane as the opening 110 of the bucket, some telescoping arms 134 at the perimeter of the valve may not have the neoprene seal fully seated against the bucket shell around the opening 110 (ie. dump hole). The tabs 166 also limit the downward travel of the valve assembly 130. The main limit to travel is the actuator cable 128 (ie. trip line) from the control head 116, which preferably takes the majority or all of the load. Nevertheless, the tabs 166 serve a useful backup role in this regard.

The remote end 138 of the telescoping rod 140, hence the remote end 138 of the telescoping arm, is hingedly connected by pin 178 to a bracket 176 attached to the interior surface 108 of the bucket adjacent the opening 110. The pin 178 is preferably removable from the bracket 176 to enable the quick removal of the valve assembly 130 from the bucket shell 102 for servicing. For example, the pin 178 may be a clevis pin.

The end of the telescoping rod 140 more proximate to the hub end 136 includes an enlarged head 174 that functions as a stop against the intermediate guide 154 to prevent the withdrawal of telescoping rod 140 from the intermediate guide 154.

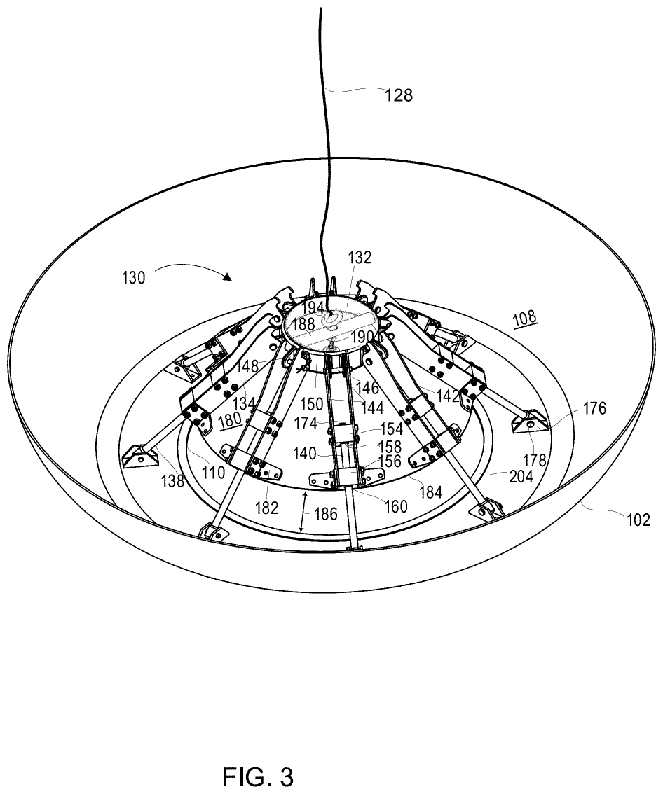

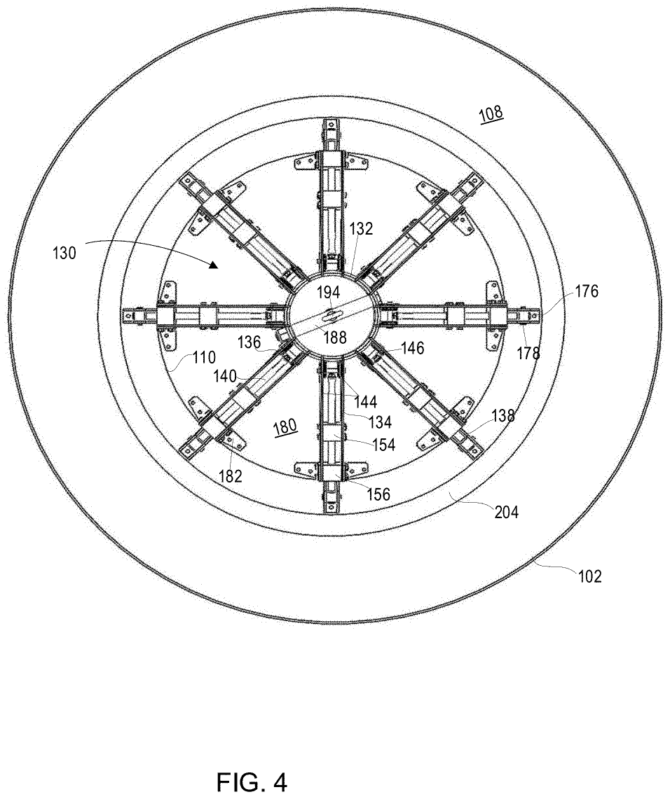

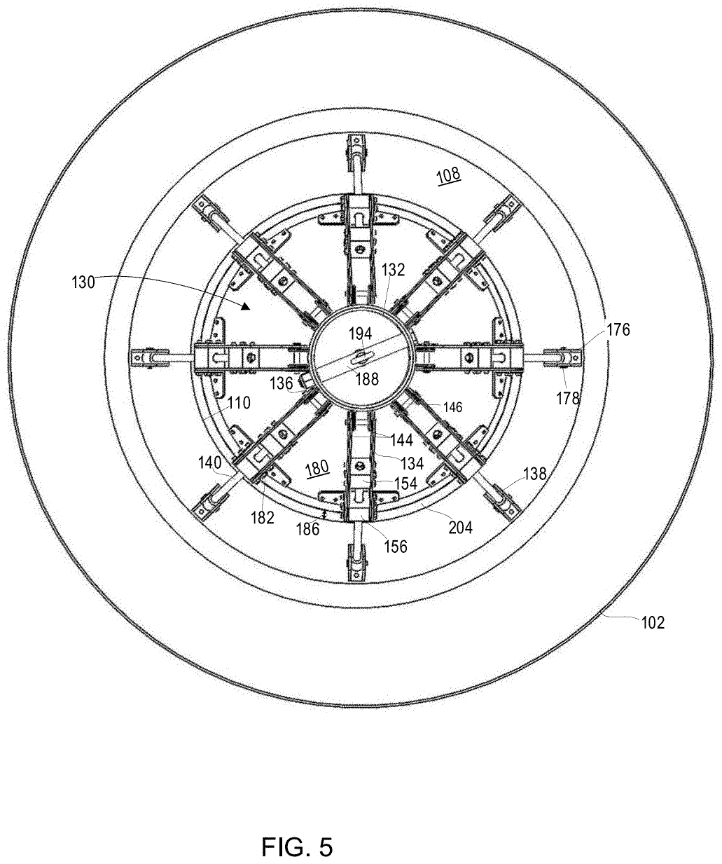

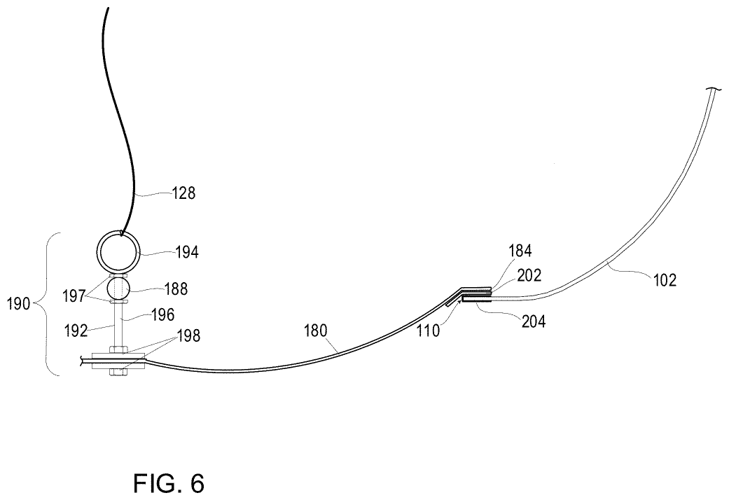

A valve flap 180 of a flexible liquid impervious material and being of sufficient dimensions to cover the opening 110 is positioned underneath the valve assembly 130 and is connected to each telescoping arm 134 by connection 182 at an adjacent location about the peripheral edge 184 of the valve flap 180. The connections 182 are positioned along the lengths of the telescoping arms 134 so that the peripheral edge 184 of the valve flap 180 covers the opening 110 when the valve assembly 130 is in a lowered position relative to the opening 110, as shown in FIGS. 2 and 4, and the peripheral edge 184 provides a gap 186 to the opening 110 when the valve assembly 130 is in a raised position relative to the opening 110, as shown in FIGS. 3 and 5 to allow liquid to flow out of the bucket 100. A center of the valve flap 180 is connected to the hub 132 by a linkage 190, which in the illustrated embodiment, comprises an eye bolt 192 having an eyelet 194 and a bolt portion 196 that extends from the eyelet 194, passes through rod 188, and terminates in a pair of nut and washer combinations 198 that between them sandwich the material of the valve flap 180, as best shown in FIG. 6. It is important that when the hub 132 is lifted that the center of the valve flap 180 (valve disc) is simultaneously lifted otherwise the valve may be incapable of dumping. A pair of lock nuts 197 on each side of the rod 188 position and secure the eye bolt 192 to the rod 188.

Also referring in particular to FIG. 6, the bottom surface of the peripheral edge 184 of the valve flap 180 is provided with a ring seal 202, such as a ring of neoprene foam about ¼″ thick and 1″ wide, that seats between the peripheral edge 184 and the material adjacent the bucket opening 110. Downward pressure of the water in the bucket creates a localized high-pressure loading where the valve flap 180 is forced against the edge of the opening 110 (ie. “wraps” around the dump hole), and the ring seal 202 distributes the load and provides the sealing between the valve flap 180 and the opening 110. The ring seal 202 may be held in place by the same bolts that affix the valve flap 180 to the connections 182.

Further referring to FIG. 6, the bucket material adjacent opening 110 is provided with a seal 204, preferably of an elastomer-coated material that is folded around the material edge surrounding opening 110 of the bucket. An example of the seal 204 may be a urethane coated belt webbing trim that wraps around the edge of opening 110 to provide a good seal with the neoprene of the ring seal 202. The neoprene of the ring seal 202 projects beyond the edge of the dump hole in effect “wrapping” itself around the edge and forced onto the edge by the weight of the water in the bucket. This is where most of the sealing takes place.

The hub 132 is connected to actuator cable 128 that is operable to raise and lower the valve assembly 130 as a result of actuation of the control head 116 by the pilot or bucket operator from inside the helicopter. Hence, the pilot or bucket operator is able to remotely raise the valve assembly 130 to open the valve 112 to release liquid from the bucket 100, and to remotely lower the valve assembly 130 to close the valve 112 and stop the release liquid from the bucket 100.

In the illustrated embodiment, a rod 188 (such as a nut and bolt shown) spans a diameter of the hub 132 and eye bolt 192 with an eyelet 194 is located centrally on the rod 188 and provides a point of attachment for the actuator cable 128 that is centrally located on the valve 112. It is preferable the actuator cable 128 pulls at or near the center of the hub 132, hence the center of the valve assembly 130) so that the telescoping arms 134 are symmetrically loaded.

In operation of the bucket 100 of the present invention, the pilot or bucket operator remotely actuates the control head 116 via a control in the helicopter to open or close the valve 112. The control in the helicopter is in communication with the control head 116 via control cable 126. The control head 116 retracts the actuator cable 128, which is connected to the hub 132, to open the valve 112, and the control head 116 extends the actuator cable 128 to close the valve 112.

To fill the bucket 100 with water, the pilot flies over a body or reservoir of water and lowers the bucket 100 into the water. The pilot or bucket operator activates the control head 116 to extend the actuator cable 128 to enable the valve 112 to close. As the bucket 100 fills, the pilot lifts it out of the body of water, and the head pressure of the water in the bucket 100 acts upon the valve 112 to urge it into the closed position. If the pilot determines that there is too much water in the bucket, the pilot or the bucket operator actuates the control head 116 to open the valve 112 for a sufficient time to drop a desired volume (hence weight) of water. Likewise, once the helicopter has reached a desired drop point for the water, the pilot or the bucket operator actuates the control head 116 to open the valve 112 for a sufficient time to drop a desired volume on the target. When the bucket 100 is empty, the process is repeated.

Advantageously, the valve 112 of the present invention is lightweight, of relatively simple construction, and collapsible to enable the valve 112 to collapse along with a collapsible firefighting bucket 100 for storage and transport when not in use. Additionally, the valve 112 may be opened and closed with liquid in the bucket 100 to enable multiple liquid drops. This also enables the pilot or bucket operator to adjust the water load upon takeoff from the body of water by either keeping the valve 112 open for a duration as the bucket 100 is lifted out of the body of water or opening the valve 112 water after liftoff to shed water from the bucket 100 to achieve a desired load, hence a desired performance from the helicopter. This is known in the industry as “load shedding”. Forestry agencies prefer that helicopter operators refuel as few times in a day as possible to achieve more productive time in the air. However, this creates stress for the pilot since having full or nearly full fuel loads on board (hence weight), the helicopter might not be able to lift a full bucket. With load shedding, the pilot begins the lift of the bucket pulling 100% power. If the helicopter is not capable of lifting the load, the pilot then “blips” the dump button (quick push on the button), which controls the valve 112, to release (shed) a bit of water from the bucket. If one blip does not do the job, the pilot will repeat the procedure until enough water has been shed from the bucket to enable the helicopter to lift the bucket from the body of water. Load shedding accommodates the interests of both the forestry agency and the pilot. And the pilot is safer since he or she has control over the weight of the water load in the bucket.

Advantageously, there is little or no creasing or kinking of the seals of the valve assembly 130 in the stowed or folded configuration given the relaxed bend in the valve material. Hence the valve assembly 130 can be stowed in the folded configuration for extended time without the neoprene ring 202 creasing and thus minimizing the chance of a leak right after putting the bucket 100 back into service after being stored.

Advantageously, the collapsible firefighting bucket 100 with the valve 112 of the present invention may be used in muddy and debris infested water because the flexible valve flap 180 and neoprene ring 202 readily conform to bits of mud and debris to provide good sealing against water leaking from the collapsible firefighting bucket 100. In contrast, prior art valves comprising rigid construction do not perform well with muddy or debris infested water since debris interferes with the valve's ability to close completely.

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way.

Numeric ranges are inclusive of the numbers defining the range. In the specification, the word “comprising” is used as an open-ended term, substantially equivalent to the phrase “including, but not limited to”, and the word “comprises” has a corresponding meaning. Citation of references herein shall not be construed as an admission that such references are prior art to the present invention. All publications, including but not limited to patents and patent applications, cited in this specification are incorporated herein by reference as if each individual publication were specifically and individually indicated to be incorporated by reference herein and as though fully set forth herein. The invention includes all embodiments and variations substantially as hereinbefore described and with reference to the examples and drawings.

1. A valve mountable to a bottom of a container around an opening, such as an aerial firefighting bucket, to enable liquid to be released from the bottom of the container, the valve comprising:
a. a hub and a plurality of spaced telescoping arms extending radially from the hub, each telescoping arm defines a hub end that is hingedly connected to the hub and a remote end that may be connected to the bottom of the container such that the telescoping arms radiate from the hub to a periphery around the opening;
b. the hub being operable to be raised and lowered with respect to the opening such that as the hub is raised the telescoping arms extend and as the hub is lowered the telescoping arms contract;
c. a flexible liquid impervious valve flap of sufficient dimension to cover the opening and connected to the telescoping arms such that the valve flap is positioned to cover the opening as the hub is lowered toward the opening to inhibit liquid flow out of the opening, and to expose part of the opening as the hub is raised away from the opening to allow liquid to flow past the valve flap; and
d. a centrally located connector on the hub that may be coupled to an actuator mechanism for raising and lowering the hub relative to the bottom.

2. The valve as claimed in claim 1 further comprising a stop member on at least one of the hub ends that engages the hub to interfere with lowering of the hub beyond a closed position of the valve in which the valve flap covers the opening.

3. The valve as claimed in claim 1 wherein the remote ends may be removably connected to the bottom.

4. The valve as claimed in claim 1 further comprising a hinged mount on the remote ends by which the remote ends may be connected for hinged movement to the bottom.

5. The valve as claimed in claim 3 further comprising a removable hinged mount on the remote ends by which the remote ends may be removably connected for hinged movement to the bottom.

6. The valve as claimed in claim 1 further comprising a ring seal around the periphery of the valve flap for engaging the bottom around the opening.

7. The valve as claimed in claim 2 wherein the remote ends may be removably connected to the bottom.

8. The valve as claimed in claim 2 further comprising a ring seal around the periphery of the valve flap for engaging the bottom around the opening.

9. The valve as claimed in claim 7 further comprising a ring seal around the periphery of the valve flap for engaging the bottom around the opening.

10. The valve as claimed in claim 6 further comprising a stop member on at least one of the hub ends that engages the hub to interfere with lowering of the hub beyond a closed position of the valve in which the valve flap covers the opening.

11. The valve as claimed in claim 10 wherein the remote ends may be removably connected to the bottom.

12. The valve as claimed in claim 1 wherein each telescoping arm comprises a fixed segment that is hingedly connected to the hub and a rod segment slidably mounted to the fixed segment for telescoping longitudinal movement relative thereto and defining the remote end of the telescoping arm.

13. The valve as claimed in claim 12 further comprising a stop member on at least one of the hub ends of the fixed segments to engage the hub to interfere with lowering of the hub beyond a closed position of the valve in which the valve flap covers the opening.

14. The valve as claimed in claim 13 wherein in the closed position, the fixed segments span the opening and the valve flap is connected to the fixed segments such that the valve flap covers the opening, and in an open position, the fixed segments and the valve flap define a gap to the opening.

15. The valve as claimed in claim 14 further comprising a ring seal around the periphery of the valve flap for engaging the bottom around the opening.

16. The valve as claimed in claim 15 wherein the fixed segment comprises parallel plates hingedly connected to the hub and a low friction guide mounted between the plates to slidably support the rod segment.

17. The valve as claimed in claim 16 wherein the rod segment further includes a slide stop cooperating with the guide to prevent detachment of the rod segment from the guide.

18. A firefighting bucket comprising:
a. an open bucket body having an open upper rim to facilitate filling from an open body of water, a side wall extending downwardly from the rim and a bottom cooperating with the side wall and having an opening; and
b. a valve as claimed in claim 1 mounted on the bottom and cooperating with the opening to control liquid flow out of the bucket body.

19. A firefighting bucket comprising:
a. an open bucket body having an open upper rim to facilitate filling from an open body of water, a side wall extending downwardly from the rim and a bottom cooperating with the side wall and having an opening; and
b. a valve as claimed in any claim 1 mounted on the bottom and cooperating with the opening to control liquid flow out of the bucket body.

20. A firefighting bucket comprising:
a. an open bucket body having an open upper rim to facilitate filling from an open body of water, a side wall extending downwardly from the rim and a bottom cooperating with the side wall and having an opening; and
b. a valve as claimed in any claim 1 mounted on the bottom and cooperating with the opening to control liquid flow out of the bucket body.
